(19) United States
(12) Patent Application Publication
(10) Pub. No.: US 2010/0161205 A1
(43) Pub. Date: Jun. 24, 2010

(54) SYSTEM FOR PROVIDING REAL-TIME TRAFFIC INFORMATION USING WIRELESS NETWORK AND A METHOD THEREOF

(75) Inventors: Kyuhyung KIM, Daegu (KR); Hogeun Lee, Daejeon-city (KR); Gwangsu Kim, Daejeon-city (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon-city (KR)

(21) Appl. No.: 12/582,784

(22) Filed: Oct. 21, 2009

(30) Foreign Application Priority Data
Dec. 22, 2008 (KR) 10-2008-0131559

(51) Int. Cl. G08G 1/00

(52) U.S. Cl. 701/118; 701/119

(57) ABSTRACT

The present invention relates to a system for providing real-time traffic information using a wireless network and a method thereof, particularly a system for providing real-time traffic information using a wireless network, by using a wireless network technology for preventing a traffic accident and an accident due to traffic congestion, and a method of providing real-time traffic information using a wireless network. A system for providing real-time traffic information using a wireless network according to an embodiment of the present invention includes: one or more vehicle velocity information collectors that are disposed on a road to establish a wireless network for sharing information, and collect vehicle velocity information of vehicles on the road; and a traffic information provider that receives the vehicle velocity information from the one or more vehicle velocity information collectors and provides a traffic information based on the vehicle velocity information.

### RELATED APPLICATIONS

The present application claims priority to Korean Patent Application Serial Number 10-2008-0131559, filed on Dec. 22, 2008, the entirety of which is hereby incorporated by reference.

### BACKGROUND OF THE INVENTION

1. Field of the Invention

The present invention relates to a system for providing real-time traffic information using a wireless network and a method thereof, particularly a system for providing real-time traffic information using a wireless network, by using a wireless network technology for preventing a traffic accident and an accident due to traffic congestion, and a method of providing real-time traffic information using a wireless network.

2. Description of the Related Art

In general, the diffusion rate of vehicle increases in a geometric progression as the industry becomes more developed, which exceeds the capacity of the existing network of roads for vehicles. Accordingly, car navigation system that provide traffic information using traffic conditions of roads and GPS information, such as a navigation, are being widely used in recent years.

Recently, traffic information providers that provide vehicles traveling on a road with information about the front area of the road are also widely used. The traffic information providers use a method that receive information about road conditions from a resource center providing traffic information, and guide vehicles. The traffic information is directly inputted by a traffic reporter or the traffic information of the front area of a road is collected by sensors installed in the road.

FIG. 1 is an exemplary view illustrating a method of providing traffic information according to the related art.

Referring to FIG. 1, a method of providing traffic information of the related art provides a vehicle 1 coming from the rear area with information, such as a traffic accident on a road or traffic congestion, using a traffic information provider 2 (e.g. an electric bulletin board) installed on a common road or a highway 3. For example, the traffic information provider provides drivers with information by showing messages, such as “Accident 10 km ahead under settlement” or “Traffic congestion 20 km ahead”.

As described above, a method of providing traffic information of the related art provides traffic conditions on roads, using a traffic information provider disposed on the roads to the user. The method uses a way of providing drivers with the traffic conditions of roads collected at a traffic center etc., using electric bulletin boards installed on the roads.

However, according to the method of providing traffic information of the related art, it is difficult to know the actual traffic conditions (e.g., traffic congestion due to a traffic accident or natural traffic congestion) at the front area and the reliability of the traffic information provided at present is deteriorated. That is, possibility of a traffic accident increases, because it is difficult to provide in real time the actual traffic conditions of the front area of a road.

Therefore, the method of providing traffic information of the related art had a problem in that additional traffic accidents may be caused because it is impossible to know in real time traffic accidents and traffic congestion at the front area of a road.

### SUMMARY OF THE INVENTION

The present invention addresses the problem described above and it is an object of the invention to provide a system and a method for providing a driver with real-time traffic information using a wireless network, by using a wireless network technology.

A system for providing real-time traffic information according to an embodiment of the present invention includes: one or more vehicle velocity information collectors that are disposed on a road to establish a wireless network for sharing information, collect vehicle velocity information of vehicles on the road, and correlate the vehicle velocity information; and a traffic information provider that receives the correlated vehicle velocity information from the one or more vehicle velocity information collectors and provides a traffic information that is determined based on the correlated vehicle velocity information.

Further, it is preferable that the system for providing real-time traffic information further includes a vehicle velocity information generator that is equipped in the vehicle to generate vehicle velocity information, and outputs the generated vehicle velocity information to the vehicle velocity information collectors.

Further, it is preferable that the vehicle velocity information collector includes a sensor that measures the velocity of a vehicle positioned at a predetermined area of the road.

Further, it is preferable that when the collected vehicle velocity information exceeds a predetermined velocity, the vehicle velocity information collector excludes corresponding vehicle velocity information.

Further, it is preferable that the traffic information provider classifies the vehicle velocity information transmitted from the vehicle velocity information collectors for each collection position, and determines whether a traffic accident and traffic congestion occur at each area.

A system for providing real-time traffic information according to another embodiment of the present invention includes: one or more vehicle velocity information collectors that are disposed on a road to establish a wireless network for sharing information, collect vehicle velocity information of vehicles on the road, and correlate the vehicle velocity information; one or more traffic information provider that receive the correlated vehicle velocity information from the one or more vehicle velocity information collectors and provide a traffic information that is determined based on the correlated vehicle velocity information; and a traffic information management server that checks the entire traffic condition of the road by receiving traffic information from the traffic information providers, and provides the traffic information to the traffic information providers.

Further, it is preferable that the system for providing real-time traffic information further includes a vehicle velocity information generator that is equipped in the vehicle to generate vehicle velocity information, and outputs the generated vehicle velocity information to the vehicle velocity information collectors.

Further, it is preferable that the vehicle velocity information collector includes a sensor that measures the velocity of a vehicle positioned at a predetermined area of the road.

Further, it is preferable that when the collected vehicle velocity information exceeds a predetermined velocity, the vehicle velocity information collector excludes corresponding vehicle velocity information.

Further, it is preferable that the traffic information provider classifies the vehicle velocity information transmitted from the vehicle velocity information collectors for each position, and determines whether a traffic accident and traffic congestion occur at each area.

Further, it is preferable that when the generated vehicle velocity information exceeds a predetermined velocity, the vehicle velocity information generator excludes output of corresponding vehicle velocity information.

A method of providing real-time traffic information according to an embodiment of the present invention includes: collecting vehicle velocity information of vehicles on a road, using one or more vehicle velocity information collectors that are disposed on the road to establish a wireless network for sharing information; and providing traffic information by checking a traffic information condition on the basis of vehicle velocity information shared and transmitted by the vehicle velocity information collectors, using a traffic information provider.

Further, it is preferable that the method of providing real-time traffic information further includes generating vehicle velocity information, by using a vehicle velocity information generator equipped in a vehicle, and outputting the generated vehicle velocity information to the vehicle velocity information collectors.

Further, it is preferable that the outputting of the generated vehicle velocity information excludes corresponding vehicle velocity information, when the collected vehicle velocity information exceeds a predetermined vehicle velocity.

Further, it is preferable that the providing of traffic information classifies the vehicle velocity information transmitted from the vehicle velocity information collectors for each collection position, and determines whether a traffic accident and traffic congestion occur at each area.

A method of providing real-time traffic information according to another embodiment of the present invention includes: collecting vehicle velocity information of vehicles on a road, using one or more vehicle velocity information collectors that are disposed on the road to establish a wireless network for sharing information; providing traffic information by checking a traffic information condition on the basis of vehicle velocity information shared and transmitted by the vehicle velocity information collectors, using one or more traffic information provider; and checking the entire traffic condition of the road by receiving traffic information from the traffic information providers, and providing the traffic information to the traffic information providers, using a traffic information management server.

Further, it is preferable that the method of providing real-time traffic information further includes generating vehicle velocity information, by using a vehicle velocity information generator equipped in a vehicle, and outputting the generated vehicle velocity information to the vehicle velocity information collectors.

Further, it is preferable that the outputting of the generated vehicle velocity information excludes corresponding vehicle velocity information, when the collected vehicle velocity information exceeds a predetermined vehicle velocity.

Further, it is preferable that the providing of traffic information classifies the vehicle velocity information transmitted from the vehicle velocity information collectors for each collection position, and determines whether a traffic accident and traffic congestion occur at each area.

According to the present invention, it is possible to prevent an accident that may be caused on a congested road by providing a driver with traffic information.

### BRIEF DESCRIPTION OF THE DRAWING

FIG. 1 is an exemplary view illustrating a method of providing traffic information according to the related art;

FIG. 2 is a block diagram illustrating a system for providing traffic information according to an embodiment of the present invention;

FIG. 3 is an exemplary view illustrating the configuration of a system for providing traffic information according to an embodiment of the present invention;

FIG. 4 is an exemplary view illustrating an example of collecting vehicle velocity information in a vehicle velocity information collector shown in FIG. 2;

FIG. 5 is a block diagram illustrating the internal configuration of vehicle velocity information collector according to the present invention;

FIG. 6 is a block diagram illustrating the internal configuration of a vehicle velocity information generator according to the present invention;

FIG. 7 is a block diagram illustrating the internal configuration of a traffic information provider according to the present invention;

FIG. 8 is an exemplary view illustrating the configuration of a system for providing vehicle velocity information according to another embodiment of the present invention; and

FIG. 9 is a flowchart illustrating a method of providing traffic information according to another embodiment of the present invention.

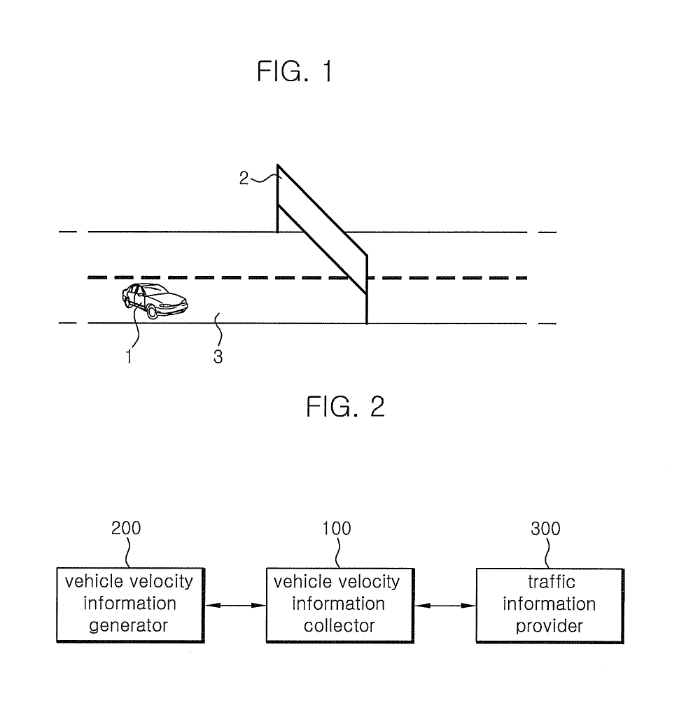

### DETAILED DESCRIPTION OF THE PREFERRED EMBODIMENTS

The present invention will be described below with reference to the accompanying drawings. Herein, the detailed description of a related known function or configuration that may make the purpose of the present invention unnecessarily ambiguous in describing the present invention will be omitted. Exemplary embodiments of the present invention are provided so that those skilled in the art may more completely understand the present invention. Accordingly, the shape, the size, etc., of elements in the figures may be exaggerated for explicit comprehension.

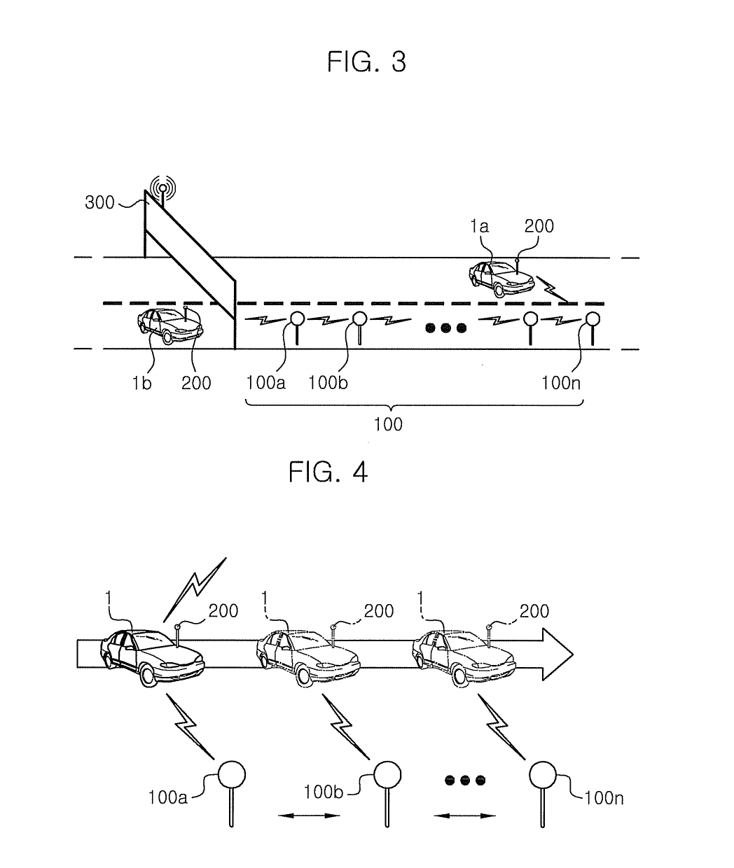

FIG. 2 is a block diagram illustrating a system for providing traffic information according to an embodiment of the present invention, FIG. 3 is an exemplary view illustrating the configuration of a system for providing traffic information according to an embodiment of the present invention, and FIG. 4 is an exemplary view illustrating an example of collecting vehicle velocity information in a vehicle velocity information collector shown in FIG. 2.

Referring to FIGS. 2 and 3, a system for providing traffic information according to an embodiment of the present invention includes a vehicle velocity information generator 200, a vehicle velocity information collector 100, and a traffic information provider 300. Wireless network is established between the components of the system for providing traffic information. For example, the wireless network establishes a USN (Ubiquitous Sensor Network), a WSN (Wireless Sensor Network) or other types of wireless networks.

The vehicle velocity information generator 200 generates vehicle velocity information by calculating the velocity of a vehicle 1a on a road and outputs the generated vehicle velocity information using a wireless signal. The vehicle velocity information generated by the vehicle velocity information generator 200 is calculated by using GPS reception signal, a velocity sensor or the like. For example, the velocity of a vehicle that is moving is calculated by the positional change and a corresponding time difference.

In this configuration, the vehicle velocity information generator 200 is configured to be able to detect the velocity of the vehicle 1a on the road, and preferably, it is equipped in the vehicle, and generates and outputs the vehicle velocity information in real time. Accordingly, it generates vehicle velocity information of one or more vehicles traveling on the road in real time.

Further, the vehicle velocity information generator 200 may be configured to continuously store velocity information of a vehicle by cooperating with equipment of the vehicle, such as a black box.

The vehicle velocity information collector 100 collects vehicle velocity information of the vehicle 1a on the road. It collects the vehicle velocity information of an adjacent vehicle by receiving the wireless signal outputted from the vehicle velocity information generator 200.

Further, it is preferable to dispose one or more of the vehicle velocity information collector 100 on the road to implement a wireless network. The vehicle velocity information collectors 100 collect vehicle velocity information while sharing the information between them, using the USN, the WSN, or other types of wireless networks.

A plurality of vehicle velocity information collectors 100 are disposed at a predetermined distance on a road to implement one wireless network therebetween, as shown in FIG. 4, such that one vehicle velocity information collector 100n collects the velocity information of an adjacent vehicle and shares the information with other adjacent vehicle velocity information collectors 100a to 100n. For example, the vehicle velocity information collector 100 disposed near a road collects the vehicle velocity information generated from vehicle velocity information generator 200 equipped in a plurality of vehicles traveling on the road. Accordingly, the vehicle velocity information collectors 100a to 100n transmit the collected vehicle velocity information to other vehicle velocity information collectors 100a to 100n and operate with each other.

Further, the vehicle velocity information collector 100 does not selectively collect and share the vehicle velocity information, when the vehicle velocity included in the collected vehicle velocity information exceeds a predetermined velocity. For example, when the speed limit of a road is 80 km to 100 km and the velocity included in the collected vehicle velocity information is 80 km or more, the vehicle velocity information collector 100 does not collect or transmit the corresponding information, because there is no occurrence of a traffic accident or traffic congestion. Therefore, the vehicle velocity information collector 100 effectively uses the wireless network by not sharing unnecessary information.

Further, the vehicle velocity information collector 100 may be configured to collect vehicle velocity information of a vehicle on a road by further including a measuring sensor therein to selectively know the velocity of a vehicle without the vehicle velocity information generator 200.

The traffic information provider 300 receives as a wireless signal the vehicle velocity information collected by one or more of the vehicle velocity information collectors 100a to 100n through the wireless network and analyzes the traffic condition of the road, and then provide traffic information in accordance with the analyzed result. The traffic information provider 300 may be configured to receive the vehicle velocity information shared by other vehicle velocity information collectors 100a, 100b by being connected with an adjacent vehicle velocity information collector 100n by a wire.

The traffic information provider 300 is configured to be able to transmit and collect data in wireless communication with the vehicle velocity information collector 100. That is, the traffic information provider 300 and the plurality of vehicle velocity information collectors 100 are configured to share and transmit information by implementing an USN, WSN, or other wireless networks.

Further, it is preferable to install the traffic information provider 300 on a road to provide traffic information about the front area such that a driver in the vehicle 1b coming from the rear area of the road can recognize the information. Accordingly, the traffic information provider 300 provides a driver of a vehicle coming from the rear area of a road with traffic information of the front area of the road in real time, that is, the traffic condition of the front area of the road, such as a traffic accident or traffic congestion, thereby preventing additional accidents.

It is preferable that the traffic information provider 300 is configured to provide the traffic information using a electric bulletin board or other displays, or directly provide the traffic information to the corresponding vehicle, using wireless communication. For example, the traffic information provider 300 shows a message “Traffic accident in the front area” on an electric bulletin board, or provides the traffic information to the navigation of a vehicle to display it.

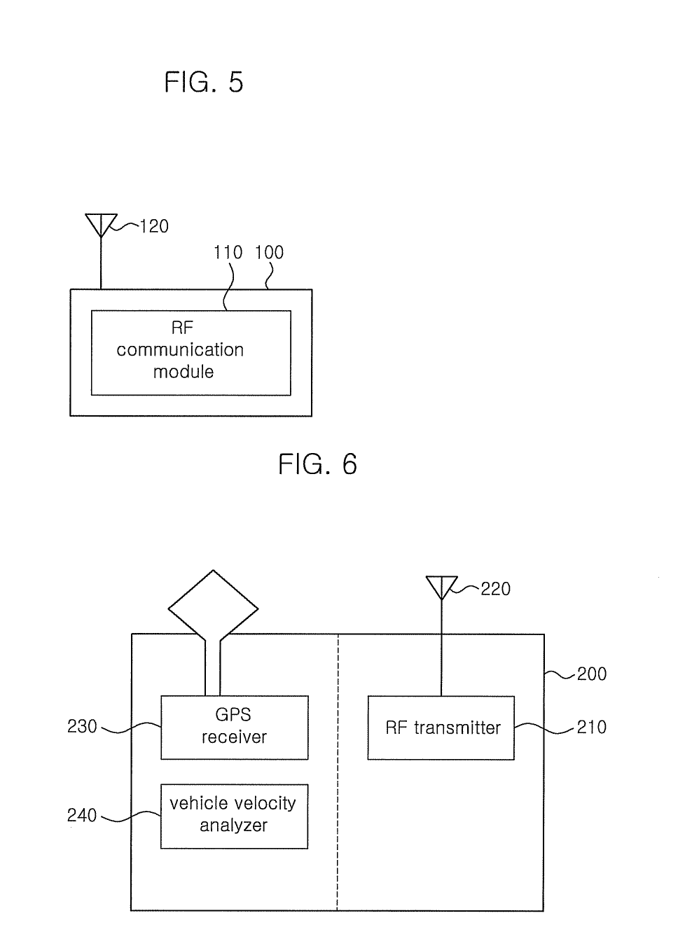

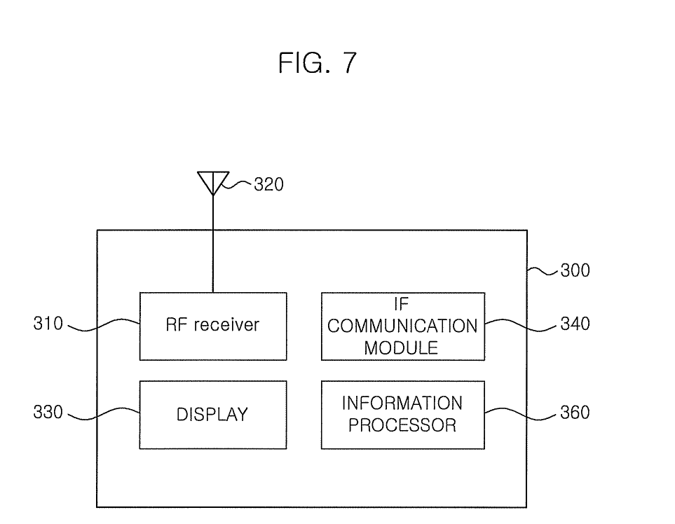

FIG. 5 is a block diagram illustrating the internal configuration of a vehicle velocity information collector according to the present invention, FIG. 6 is a block diagram illustrating the internal configuration of a vehicle velocity information generator 200 according to the present invention, and FIG. 7 is a block diagram illustrating the internal configuration of a traffic information provider 300 according to the present invention.

The vehicle velocity information collector 100 according to the present invention is described in detail with reference to FIG. 5. The vehicle velocity information collector 100 includes an RF communication module 110 and an antenna 120. The RF communication module 110 receives vehicle velocity information of the vehicle 1a on the road which is transmitted through the antenna 120. The RF communication module 110 transmits the received vehicle velocity information to the other devices. That is, the RF communication module 110 cooperates with the RF communication modules 110 of other vehicle velocity information collectors 100n to 100a by transmitting the received vehicle velocity information to them.

Further, the RF communication module 110 is configured to transmit/receive vehicle velocity information, using an USN, WSN, or other wireless networks.

Further, the RF communication module 110 does not selectively collect and share the vehicle velocity information, when the vehicle velocity included in the collected vehicle velocity information exceeds a predetermined velocity. For example, when the speed limit of a road is 80 km to 100 km and the velocity included in the collected vehicle velocity information is 80 km or more, the RF communication module 110 does not transmit the corresponding information, because there is no occurrence of a traffic accident or traffic congestion.

When receiving data over a predetermined velocity, the RF communication module 110 may be configured not to transmit the received information to other vehicle velocity information collectors. Accordingly, it is possible to reduce the traffic of the network that would be generated by transmitting/receiving unnecessary data.

Further, the vehicle velocity information collector 100 may further include a measuring sensor therein to selectively know the velocity of a vehicle without a vehicle velocity information generator.

Referring to FIG. 6, the vehicle velocity information generator 200 according to an embodiment of the present invention includes a GPS information receiver 230, a vehicle velocity analyzer 240, and an RF transmitter 210.

The GPS receiver 230 receives GPS signals generated by a GPS satellite. The GPS receiver 230 receives GPS signals including the present positional coordinates of a vehicle in real time.

The vehicle velocity analyzer 240 calculates the velocity of the vehicle using the GPS signal received by the GPS receiver 230. The vehicle velocity analyzer 240 generates the traveling velocity information of the vehicle by comparing the GPS signals sequentially received by the GPS receiver 230.

The RF transmitter 210 outputs the vehicle velocity information calculated by the vehicle velocity analyzer 240. The RF transmitter 210 converts the vehicle velocity information into a wireless signal in real time and transmits it to the outside through the antenna 220.

Referring to FIG. 7, the traffic information provider according to an embodiment of the present invention includes an RF receiver 310, an information processor 360, and a display 330.

The RF receiver 310 allows for communication with the vehicle velocity information collector 100. The RF receiver 310 receives in real time the vehicle velocity information collected between the vehicle velocity information collectors 100 through an antenna 320.

The information processor 360 determines the traffic condition by analyzing and processing the vehicle velocity information inputted through the RF receiver 310. The information processor 360 determines the traffic conditions for each position of the road by classifying one or more vehicle velocity information, which is received by the RF receiver 310, for each position. For example, when the vehicle velocity included in vehicle velocity information collected 10 km ahead is 20 km, it determines that traffic congestion occurs at the position.

The display 330 provides traffic information to a driver. The display 330 sequentially displays the traffic information processed by the information processor 360. It displays the information such that a driver can easily recognize it, using colors, characters, and symbols.

Meanwhile, it is preferable for the traffic information provider 300 to further include an IF communication module 340 for communication with the outside. The IF communication module 340 provides the traffic information of a road, in various communication methods, such as LAN, WLAN, CDMA, and HSDPA. That is, the IF communication module 340 transmits the traffic information of a corresponding position to another traffic information provider 300 for sharing.

A method of providing traffic information according to an embodiment of the present invention is described hereafter, in which the system for providing traffic information according to an embodiment of the present invention is exemplified.

The system for providing traffic information having the above configuration according to an embodiment of the present invention is exemplified. Referring to FIG. 3, the vehicle velocity information generator 200 equipped in the vehicle 1a at the front area of a road generates vehicle velocity information of the vehicle using a GPS signal and transmits it to the outside. For example, when the velocity of the vehicle 1a at the front area of the road is 10 km, it converts the vehicle velocity information and transmits it to the outside, using a wireless signal.

The vehicle velocity information collector 100n disposed adjacent to the vehicle 1a at the front area of the road receives the wireless signal outputted from the vehicle velocity information generator 200 and collects the vehicle velocity information of the adjacent vehicle 1a. The vehicle velocity information collector 100n transmits the vehicle velocity information to another vehicle velocity information collector 100b in the wireless network and shares the vehicle velocity information. In this way, the vehicle velocity information collectors 100n to 100a collect the vehicle velocity information transmitted from the adjacent vehicle and sequentially share the vehicle velocity information with each other.

Thereafter, the traffic information provider 300 receives the vehicle velocity information, which is collected by the wireless network between one or more vehicle velocity information collectors 100, by a wireless signal, and analyzes the traffic condition for each position of the front area of the road. For example, when the velocity of a vehicle at a position of 10 km of the front area is 10 km and a velocity of a vehicle at a position of 20 km of the front area is 80 km, the traffic information provider 300 determines that a traffic accident occurs at the position of 10 km of the front area and informs the traffic condition.

The traffic information provider 300 provides in real time the driver of a vehicle coming from the rear area with traffic information of the front area, that is, the traffic condition of the front area of the road, such as a traffic accident on a road or traffic congestion. In this way, the traffic information provider 300 makes it possible to prevent additional accidents of vehicles coming from the rear area by providing the traffic condition of the front area of the road in real time. For example, the traffic information provider 300 shows a message “Traffic accident up ahead” on an electric bulletin board, or provides traffic information to the navigation device of a vehicle to display it.

A system for providing traffic information according to another embodiment of the present invention is described hereafter with reference to the accompanying drawings. The system for providing traffic information according to another embodiment of the present invention is extended from the embodiment described above, further including a traffic information management server 500. The same configuration as the embodiment described above is considered to be the same.

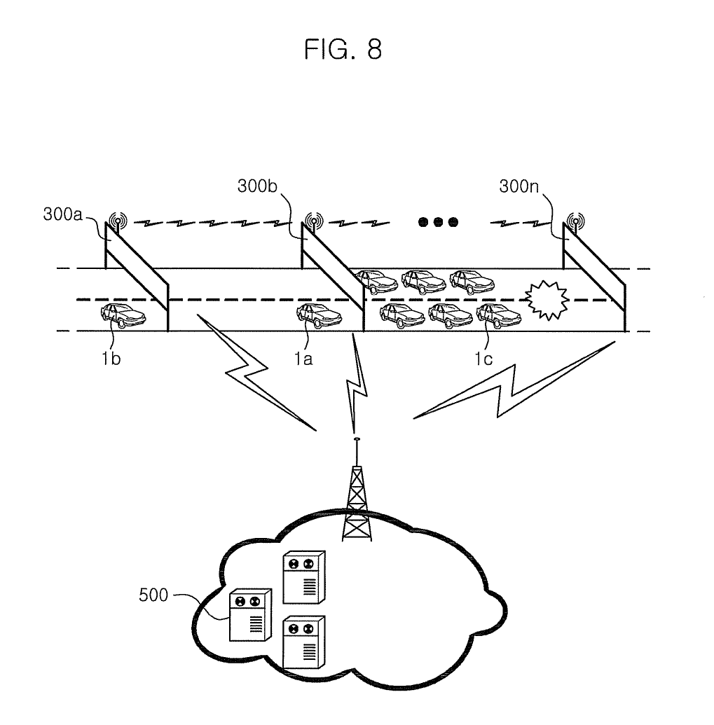

FIG. 8 is an exemplary view illustrating the configuration of a system for providing vehicle velocity information according to another embodiment of the present invention.

Referring to FIG. 8, a system for providing a vehicle velocity information according to another embodiment of the present invention includes one or more vehicle velocity information generators 200, one or more vehicle velocity information collectors 100, one or more traffic information providers 300, and a traffic information management server 500. The system for providing vehicle velocity information according to another embodiment of the present invention provides a driver with traffic information determined by the traffic information provider 300 installed at a predetermined position, and if necessary, transmits the traffic information to the traffic information management server. The traffic information management server determines the entire road condition, using the traffic information received from the traffic information provider 300 and provides the traffic information to another traffic information provider 300 such that a traffic accident and traffic congestion on a road of a predetermined area are shared.

A wireless network is implemented between the components of the system for providing traffic information.

For example, the wireless network establishes USN (Ubiquitous Sensor Network), WSN (Wireless Sensor Network) or other types of wireless network.

The vehicle velocity information generator 200 generates vehicle velocity information by calculating the velocity of vehicles 1c, 1a on a road and outputs the generated vehicle velocity information using a wireless signal. The vehicle velocity information generated by the vehicle velocity information generator 200 is calculated by using GPS reception information or a velocity sensor. For example, the velocity of a vehicle that is moving is calculated by the positional change and a corresponding time difference.

In this configuration, the vehicle velocity information generator 200 is configured to be able to detect the velocity of the vehicles 1c, 1a on the road, and preferably, it is equipped in the vehicle, and generates and outputs the vehicle velocity information in real time. Accordingly, it generates vehicle velocity information of one or more vehicles traveling on the road in real time.

Further, the vehicle velocity information generator 200 may be configured to continuously store velocity information of a vehicle by cooperating with equipment of the vehicle, such as a black box.

The vehicle velocity information collector 100 collects vehicle velocity information of the vehicles 1c, 1a on the road. It collects the vehicle velocity information of an adjacent vehicle by receiving the wireless signal outputted from the vehicle velocity information generator 200.

Further, it is preferable to dispose one or more of the vehicle velocity information collector 100 on the road to implement a wireless network. The vehicle velocity information collectors 100 collect vehicle velocity information while sharing the information between them, using the USN, the WSN, or other types of wireless network.

A plurality of vehicle velocity information collectors 100 are disposed at a predetermined distance on a road to implement one wireless network therebetween, such that one vehicle velocity information collector 100n collects the velocity information of an adjacent vehicle and shares the vehicle velocity information with other adjacent vehicle velocity information collectors 100.

Further, the vehicle velocity information collector 100 does not selectively collect and share the vehicle velocity information, when the vehicle velocity included in the collected vehicle velocity information exceeds a predetermined velocity. For example, when the speed limit of a road is 80 km to 100 km and the velocity included in the collected vehicle velocity information is 80 km or more, the vehicle velocity information collector 100 does not collect or transmit the corresponding information, because there is no problem of a traffic accident or traffic congestion. Therefore, the vehicle velocity information collector 100 effectively uses the wireless network by not sharing unnecessary information.

Further, the vehicle velocity information collector 100 may be configured to collect vehicle velocity information of a vehicle on a road by further including a measuring sensor therein to selectively know the velocity of a vehicle without the vehicle velocity information generator 200.

The traffic information provider 300 receives as a wireless signal the vehicle velocity information collected by one or more of the vehicle velocity information collectors 100 through the wireless network and analyzes the traffic condition of the road, and then provides traffic information in accordance with the analyzed result.

The traffic information provider 300 may be configured to receive the vehicle velocity information shared by other vehicle velocity information collector 100 by being connected with an adjacent vehicle velocity information collector 100 by a wire.

Further, it is preferable to install the traffic information provider 300 on a road to provide traffic information about the front area such that a driver in the vehicle 1a coming from the rear area of the road can recognize the information. Accordingly, the traffic information provider 300 provides a driver of a vehicle coming from the rear area of a road with traffic information of the front area of the road in real time, that is, the traffic condition of the front area of the road, such as a traffic accident or traffic congestion, thereby preventing additional accidents.

It is preferable that the traffic information provider 300 is configured to provide the traffic information using a electric bulletin board or other displays, or directly provide the traffic information to the corresponding vehicle, using wireless communication. For example, the traffic information provider 300 shows a message “Traffic accident up ahead” on an electric bulletin board, or provides the traffic information to the navigation device of a vehicle to display it.

The traffic information management server 500 collects and shares traffic information provided by one or more traffic information provides 300n to 300a. The traffic information management server 500 determines the entire road condition, using the traffic information determined by the traffic information provider 300a and provides the traffic information to the other traffic information providers 300n to 300b. Therefore, the traffic information management server 500 can provide effective traffic information guide by sharing information about a traffic accident and traffic congestion on a road at a predetermined area.

A method of providing traffic information according to another embodiment of the present invention is described hereafter with reference to the accompanying drawings.

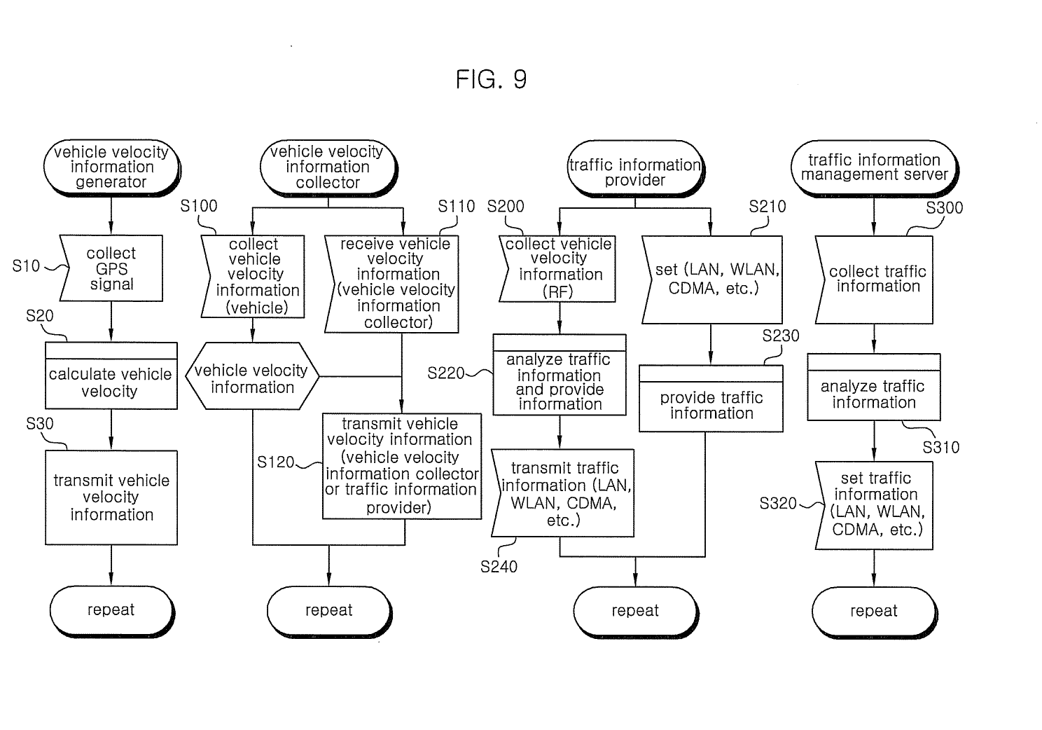

FIG. 9 is a flowchart illustrating a method of providing traffic information according to another embodiment of the present invention.

Referring to FIG. 9, first, the vehicle velocity information generator 200 collects GPS signals (S10). It is exemplified that the vehicle velocity information generator 200 is equipped in the vehicle 1a at the front area of a road shown in FIG. 8.

The vehicle velocity information generator 200 generates the vehicle velocity information of the vehicle 1a, using the collected GPS signals, and transmits the velocity to an adjacent vehicle velocity information collector 100 (S20, S30). For example, if the velocity of the vehicle 1a at the front area of the road is 10 km, it converts the vehicle velocity information and outputs it, using a wireless signal. The vehicle velocity information generator 200 repeats the steps S10 to S30.

The vehicle velocity information collector 100 receives the wireless signal outputted from the vehicle velocity information generator 200 (S100). In this way, the vehicle velocity information collector 100 is disposed adjacent to the vehicle 1a at the front area of the road.

The vehicle velocity information collector 100 simultaneously receives vehicle velocity information transmitted from another adjacent vehicle velocity information collector 100 (S110).

Thereafter, the vehicle velocity information collector 100 transmits the vehicle velocity information of the adjacent vehicle 1a collected by the vehicle velocity information generator 200 and the vehicle velocity information transmitted from another vehicle velocity information collector 100, to another vehicle velocity information collector 100 or the traffic information provider 300 (S120). That is, the vehicle velocity information collectors 100 continuously transmit and share the collected vehicle velocity information by the wireless network. In this way, the vehicle velocity information collectors 100 collect vehicle velocity information transmitted from adjacent vehicles and sequentially share the vehicle velocity information therebetween. In this way, the vehicle velocity information collector 100 repeats the steps S100 to S120.

The traffic information provider 300 receives the vehicle velocity information collected and shared by the wireless network between one or more vehicle velocity information collectors 100, by a wireless signal (S200). The traffic information provider 300 also receives the traffic information provided by another traffic information provider 300, from the traffic information management server 500 (S210).

The traffic information provider 300 analyzes and provides the traffic condition for each position of the front area of the road by analyzing the transmitted vehicle velocity information (S220, S230). For example, when the velocity of a vehicle 10 km ahead is 10 km and a velocity of a vehicle 20 km ahead is 80 km, the traffic information provider 300 determines that a traffic accident occurs at the position of 10 km of the front area and informs the traffic condition.

Accordingly, the traffic information provider 300 provides a driver of a vehicle coming from the rear area of a road with traffic information of the front area in real time, that is, the traffic condition of the front area of the road, such as a traffic accident or traffic congestion. In this way, the traffic information provider 300 makes it possible to prevent additional accidents of vehicles coming from the rear area by providing the traffic condition of the front area of the road in real time. For example, the traffic information provider 300 shows a message “Traffic accident up ahead” on an electric bulletin board, or provides the traffic information to the navigation device of a vehicle to display it.

Thereafter, the traffic information provider 300 outputs and provides the traffic information to another traffic information provider 300 or the traffic information management server (S240). In this way, the traffic information provider 300 repeats steps S200 to S240.

The traffic information management server 500 collects the traffic information transmitted from the traffic information providers 300 (S300).

Thereafter, the traffic information management server 500 determines the entire road condition, using the traffic information determined by the traffic information provider 300 at a predetermined area and provides the traffic information to another traffic information provider 300 (S310, S320). Therefore, the traffic information management server 500 can provide effective traffic information guide by sharing information about a traffic accident and traffic congestion on a road at a predetermined area. In this way, the traffic information management server 500 repeats steps S300 to S320.

Although, embodiments of the present invention were described above with reference to the accompanying drawings, the present invention is not limited to the embodiment and the drawings described disclosed herein and may be modified without departing from the scope of the present invention.

What is claimed is:

1. A system for providing real-time traffic information, comprising:
one or more vehicle velocity information collectors that are disposed on a road to establish a wireless network for sharing information, collect vehicle velocity information of vehicles on the road, and correlate the vehicle velocity information; and
one or more traffic information provider that receives the correlated vehicle velocity information from the one or more vehicle velocity information collectors and provides a traffic information that is determined based on the correlated vehicle velocity information.

2. The system for providing real-time traffic information according to claim 1, further comprising:
a vehicle velocity information generator that is equipped in the vehicle to generate vehicle velocity information, and outputs the generated vehicle velocity information to the vehicle velocity information collectors.

3. The system for providing real-time traffic information according to claim 1, wherein the vehicle velocity information collector includes a sensor that measures the velocity of a vehicle positioned at a predetermined area of the road.

4. The system for providing real-time traffic information according to claim 1, wherein when the collected vehicle velocity information exceeds a predetermined velocity, the vehicle velocity information collector excludes corresponding vehicle velocity information.

5. The system for providing real-time traffic information according to claim 1, wherein the one or more traffic information provider classify the vehicle velocity information transmitted from the vehicle velocity information collectors for each collection position, and determine whether a traffic accident and traffic congestion occur at each area.

6. The system for providing real-time traffic information according to claim 1, further comprising:
a traffic information management server that checks the entire traffic condition of the road by receiving traffic information from the traffic information providers, and provides the traffic information to the traffic information providers.

7. The system for providing real-time traffic information according to claim 2, wherein when the generated vehicle velocity information exceeds a predetermined velocity, the vehicle velocity information generator excludes output of corresponding vehicle velocity information.

8. A method of providing real-time traffic information, comprising:
collecting vehicle velocity information of vehicles on a road, using one or more vehicle velocity information collectors that are disposed on the road to establish a wireless network for sharing information; and
providing traffic information by checking a traffic information condition on the basis of vehicle velocity information shared and transmitted by the vehicle velocity information collectors, using a traffic information provider.

9. The method of providing real-time traffic information according to claim 8, further comprising:
generating vehicle velocity information, by using a vehicle velocity information generator equipped in a vehicle, and outputting the generated vehicle velocity information to the vehicle velocity information collectors.

10. The method of providing real-time traffic information according to claim 8, wherein the outputting of the generated vehicle velocity information excludes corresponding vehicle velocity information, when the collected vehicle velocity information exceeds a predetermined vehicle velocity.

11. The method of providing real-time traffic information according to claim 8, wherein the providing of traffic information classifies the vehicle velocity information transmitted from the vehicle velocity information collectors for each collection position, and determines whether a traffic accident and traffic congestion occur at each area.

12. A method of providing real-time traffic information using a wireless network, comprising:
collecting vehicle velocity information of vehicles on a road, using one or more vehicle velocity information collectors that are disposed on the road to establish a wireless network for sharing information;
providing traffic information by checking a traffic information condition on the basis of vehicle velocity information shared and transmitted by the vehicle velocity information collectors, using one or more traffic information providers; and
checking the entire traffic condition of the road by receiving traffic information from the traffic information providers, and providing the traffic information to the traffic information providers, using a traffic information management server.

13. The method of providing real-time traffic information according to claim 12, further comprising:
generating vehicle velocity information, by using a vehicle velocity information generator equipped in a vehicle, and outputting the generated vehicle velocity information to the vehicle velocity information collectors.

14. The method of providing real-time traffic information according to claim 12, wherein the outputting of the generated vehicle velocity information excludes corresponding vehicle velocity information, when the collected vehicle velocity information exceeds a predetermined vehicle velocity.

15. The method of providing real-time traffic information according to claim 12, wherein the providing of traffic information classifies the vehicle velocity information transmitted from the vehicle velocity information collectors for each collection position, and determines whether a traffic accident and traffic congestion occur at each area.
